(19) United States
(12) Patent Application Publication
(10) Pub. No.: US 2013/0280495 A1
(43) Pub. Date: Oct. 24, 2013

(54) GLASS FILM CUTTING METHOD AND GLASS FILM LAMINATE

(71) Applicant: NIPPON ELECTRIC GLASS CO., LTD., Shiga (JP)

(72) Inventor: Yasuhiro MATSUMOTO, Moriyama-shi (JP)

(21) Appl. No.: 13/856,125

(22) Filed: Apr. 3, 2013

(30) Foreign Application Priority Data
Apr. 5, 2012 (JP) 2012-086555

(51) Int. Cl. C03B 33/09

(52) U.S. Cl. CPC C03B 33/091
USPC 428/172; 65/112; 428/213

(57) ABSTRACT

A glass film laminate is manufactured by setting a surface roughness Ra of a surface of a glass film having a thickness of 200 μm or less to contact a support glass, which supports the glass film, and a surface of the support glass to contact the glass film to 2.0 nm or less, and by bringing the surfaces of the glass film and the support glass into surface contact with each other. After that, a laser scribing operation is carried out, in which a scribe line is formed in the glass film by propagating an initial crack through laser heating of the glass film followed by subsequent cooling of the glass film.

### TECHNICAL FIELD

The present invention relates to a glass film cutting method and a glass film laminate, and more particularly, to a technology for performing appropriate laser scribing on a glass film having a thickness of 200 μm or less.

### BACKGROUND ART

As is well known, a thinner glass sheet than in conventional ones has been promoted for use in a panel portion, a light transmissive portion, and other such portions of various electronic devices such as a display device as typified by a liquid crystal display device and an organic light-emitting diode display device, and an illumination device as typified by an organic light-emitting diode illumination device from the viewpoint of meeting with thinning and light-weighting, specified types of use, and the like.

Further, the glass sheet to be used as a component that is assembled to the above-mentioned various electronic devices such as a display device and an illumination device is required to have high flexibility, and hence, as this type of glass sheet, a glass sheet having a thickness of 200 μm or less (glass film) has been developed in recent years.

As this type of glass film, a substantially rectangular glass film obtained by removing unnecessary portions after forming is cut and separated into pieces having a predetermined size conforming to the size of, for example, a portion of the various electronic devices to which the glass film is to be assembled. In this case, there is an issue of which method is available for cutting and separating the glass film having a thickness of 200 μm or less (for example, a glass film as a mother glass).

For example, Patent Literature 1 discloses a method of forming scribe lines (laser scribing) due to a change in stress of an internal strain, which is generated in the glass sheet by irradiating the moving glass sheet with a laser beam in a spot shape and cooling, by jetting a coolant, the region heated through the laser beam irradiation. Then, this glass sheet is snapped along the scribe lines, and is accordingly cut and separated into a plurality of glass sheets having a predetermined size.

This type of general laser scribing is described in detail. As illustrated in FIG. 12, in the process of moving a glass sheet 30 in a direction D1 along a preset cleaving line 31, a heated region 33 is formed using a laser beam 32 on the preset cleaving line 31 of the glass sheet 30, and a subsequent cooled region 35 is formed using a coolant 34, such as water, on the preset cleaving line 31 as well. Then, an initial crack 36 formed at a leading end portion of the preset cleaving line 31 is propagated by a thermal stress generated due to a temperature difference between the regions 33 and 35, and accordingly a scribe line 37 is formed on the preset cleaving line 31 of the glass sheet 30.

### CITATION LIST

### Patent Literature

Patent Literature 1: JP 2001-58281 A

### SUMMARY OF INVENTION

### Technical Problem

However, the above-mentioned laser scribing disclosed in Patent Literature 1 effectively functions for a glass sheet having a thickness more than about 250 μm, but there arises a problem in that the laser scribing in the conventional configuration cannot be utilized effectively for a glass film having a thickness of 200 μm or less as described above.

Specifically, in the former case where the laser scribing is performed on the thick glass sheet, as illustrated in FIG. 13a, a heated region 33a and a cooled region 35a are formed in a thickness direction of the glass sheet 30 so that a desired thermal stress (tensile stress) is generated. As a result, the scribe line 37 is formed appropriately.

In the latter case where the laser scribing is performed on the glass film having a thickness of 200 μm or less, however, as illustrated in FIG. 13b, the cooled region 35a is formed in a thickness direction of a glass film 30x, but the heated region 33a is not formed sufficiently so that a desired thermal stress is not generated. As a result, the scribe line cannot be formed appropriately.

As described above, in the case of the glass film having a thickness of 200 μm or less, a sufficient thermal stress cannot be generated in the thickness direction through the laser heating followed by the subsequent cooling, and it is therefore difficult or impossible to form an appropriate scribe line in the glass film.

The present invention has been made in view of the above-mentioned circumstances on the laser scribing, and it is therefore a technical object thereof to form an appropriate scribe line in a glass film having a thickness of 200 μm or less by generating a sufficient thermal stress through laser heating followed by subsequent cooling.

### Solution to Problem

According to the present invention devised to achieve the above-mentioned technical object, there is provided a glass film cutting method, comprising: a laser scribing step of forming a scribe line in a glass film having a thickness of 200 μm or less by propagating an initial crack through laser heating of the glass film followed by subsequent cooling of the glass film; and a laminate manufacturing step of manufacturing a glass film laminate by setting a surface roughness Ra of each of a surface of the glass film to be brought into contact with a support glass, which is configured to support the glass film, and a surface of the support glass to be brought into contact with the glass film to 2.0 nm or less, and by bringing the surface of the glass film and the surface of the support glass into surface contact with each other, followed by the laser scribing step. Note that, the above-mentioned surface roughness Ra is measured through use of a scanning prove microscope (NanoNabi II/S-image) manufactured by SII at a scanning area of 2,000 nm, a scanning frequency of 0.95 Hz, and a scanning data count of X: 256 and Y: 256. The surface roughness Ra is represented by an average value of surface roughnesses Ra at two points in total, that is, one point at a center portion and one point at a corner portion of each of the surfaces of the glass film and the support glass to be brought into contact with each other.

With this configuration, the glass film in which the surface to be brought into contact with the support glass has the surface roughness Ra of 2.0 nm or less and the support glass in which the surface to be brought into contact with the glass film has the surface roughness Ra of 2.0 nm or less are laminated in surface contact (specifically, direct surface contact) with each other, and hence the glass film and the support glass are maintained in a state of appropriately adhering to each other even without using an adhesive or a pressure-sensitive adhesive. Therefore, when the glass film having a thickness of 200 μm or less is subjected to the laser heating followed by the subsequent cooling, the cooled region and the heated region are formed in the thickness direction of the laminate that may be assumed as a unit of the glass film and the support glass obtained through the adhesion. In other words, the cooled region and the heated region are formed in the thickness direction under a state in which the shortage of the thickness of the glass film is compensated with the thickness of the support glass. Therefore, even when the thickness is 200 μm or less, a desired thermal stress (tensile stress) is generated in the thickness direction of the laminate comprising the glass film, and hence the appropriate scribe line is formed in the glass film due to the thermal stress. Note that, it is preferred that the total thickness of the glass film and the support glass, that is, the thickness of the glass film laminate, be 250 μm or more.

In this case, it is preferred to carry out, after the laser scribing step, a separation step of separating, from the support glass, the glass film having the scribe line formed therein, and a snapping step of snapping the separated glass film along the scribe line.

With this configuration, in the separation step, the glass film having the scribe line formed therein, that is, the glass film that is not yet separated into a plurality of pieces, is separated from the support glass. Then, in the snapping step, the glass film is snapped along the scribe line, and is accordingly cut and separated into a plurality of glass films. Thus, in the process of separating the glass film from the support glass, and cutting and separating the glass film into a plurality of pieces, it is possible to effectively prevent such a situation that opposing cleaved surfaces defining the scribe line are brought into locally close contact with each other and chipping, breakage, and the like occur in the cleaved surfaces due to local stress concentration caused by the locally close contact between the cleaved surfaces, thus resulting in generation of a defective product. Further, no adhesive or pressure-sensitive adhesive is interposed as a layer between the glass film and the support glass, and hence it is also possible to avoid such a situation that the glass film is contaminated after the separation. As a result, the plurality of separated glass films can be obtained in a clean state with high quality. Note that, the glass film can be separated from the support glass relatively easily because the glass film and the support glass adhere to each other only through the surface contact therebetween.

Further, the laser scribing step may comprise forming a plurality of scribe lines crossing each other.

With this configuration, in the process of forming one of the scribe lines to be crossed and then forming the other of the scribe lines, when the other of the scribe lines passes across the one of the scribe lines, the other of the scribe lines is formed continuously without being interrupted at a passing point therebetween. This is because, when the one of the scribe lines is formed, the opposing cleaved surfaces defining this scribe line may be assumed to be substantially in contact with each other though the cleaved surfaces are separated from each other in terms of molecules thereof. Aside from the validity of the reason why the above-mentioned phenomenon occurs, as a result of the repetitive experiments conducted by the inventors of the present invention, it is found that, when the other of the scribe lines crosses and passes across the one of the scribe lines after the one of the scribe lines is formed, the other of the scribe lines is formed continuously without being interrupted at the passing point therebetween. Therefore, there is no need to form an initial crack at a leading end portion at which the other of the scribe lines passes across the one of the scribe lines, and hence the position of the initial crack formation can be set only to peripheral edge portions of the glass film. As a result, the work of forming initial cracks is facilitated. Then, the glass film in which the plurality of scribe lines crossing each other are formed as described above is separated from the support glass, and then snapped along the respective scribe lines. Thus, it is possible to prevent in advance such a situation that the opposing cleaved surfaces defining each of the scribe lines are brought into locally close contact with each other and chipping, breakage, and the like occur due to stress concentration caused by the locally close contact between the cleaved surfaces. Accordingly, the glass film can be cut and separated smoothly in a good condition.

Further, the support glass of the glass film laminate may comprise support glasses arranged so as to extend along preset cleaving lines, along which the scribe lines are to be formed in the glass film.

With this configuration, the support glasses are brought into surface contact with the glass film only at a position at which the support glasses extend along the preset cleaving lines, and hence the area of the contact surfaces of the glass film and the support glasses is reduced. Thus, as compared to the case where the glass film and the support glass are laminated in contact with each other over the entire surfaces thereof, it is possible to avoid such a situation that creases are generated due to local separation of the glass film from the support glass at the time of carrying out the laminate manufacturing step. As a result, it is possible to reduce a probability of distortion that may occur in the glass film due to the separation of the glass film. Further, when the glass film is separated from the support glass after the laser scribing step is completed, the separation of the glass film is facilitated. Moreover, when the support glass is washed and dried or inspection is carried out for the presence and absence of remaining foreign matter after the glass film is separated from the support glass, it is possible to reduce the time and effort to be required for those kinds of work.

In addition, the support glass of the glass film laminate may be thinner than the glass film.

With this configuration, it is possible to eliminate waste to be generated from the fact that the support glass to be disposed of is thicker than the glass film, and to achieve light-weighting of the glass film laminate and higher handling efficiency of the glass film laminate. Further, when the glass film is subjected to the laser heating followed by the subsequent cooling under the above-mentioned condition that the support glass is thinner than the glass film, the cooled region and the heated region are formed appropriately in the thickness direction of the glass film laminate. This configuration is advantageous in forming the scribe line more appropriately. Specifically, in view of the fact that there is no need to generate a great thermal stress when forming the scribe line in the glass film unlike a case where the glass film is subjected to full-body cutting, the support glass that is thinner than the glass film is considered to be more advantageous because the generation of the thermal stress is suppressed. Note that, when such a configuration is employed, it is preferred that the thickness of the support glass be 50 μm or more.

On the other hand, according to the present invention devised to achieve the above-mentioned technical object, there is provided a glass film laminate, comprising: a glass film having a thickness of 200 μm or less; and a support glass, which is configured to support the glass film, wherein a surface of the glass film to be brought into contact with the support glass has a surface roughness Ra of 2.0 nm or less, and a surface of the support glass to be brought into contact with the glass film has a surface roughness Ra of 2.0 nm or less, wherein the surface of the glass film and the surface of the support glass are brought into surface contact with each other to laminate the glass film and the support glass, wherein the glass film comprises a scribe line formed therein by propagating an initial crack through laser heating of the glass film followed by subsequent cooling of the glass film, and wherein the support glass is thinner than the glass film.

With this configuration, it is possible to eliminate waste to be generated from the fact that the support glass to be disposed of is thicker than the glass film, and to achieve light-weighting of the glass film laminate and higher handling efficiency of the glass film laminate. In addition, when the steps of manufacturing the glass film laminate and forming the scribe line are carried out in a factory or the like that is different from that for the separation and snapping steps, a large number of glass film laminates having the scribe line formed therein need to be transported, for example, in a packaged state. In this case, it is possible to facilitate the packaging work, increase the number of glass film laminates to be packaged into one bundle, and thus enhance the transportation efficiency. Further, according to the glass film laminate having such a configuration, for the reason described above, the appropriate scribe line is formed in the glass film having a thickness of 200 μm or less.

On the other hand, according to the present invention devised to achieve the above-mentioned technical object, there is provided a glass film laminate, comprising: a glass film having a thickness of 200 μm or less; and a support glass, which is configured to support the glass film, wherein a surface of the glass film to be brought into contact with the support glass has a surface roughness Ra of 2.0 nm or less, and a surface of the support glass to be brought into contact with the glass film has a surface roughness Ra of 2.0 nm or less, wherein the surface of the glass film and the surface of the support glass are brought into surface contact with each other to laminate the glass film and the support glass, and wherein the support glass is thinner than the glass film. In this case, the glass film may be subjected to the scribe line formation in the subsequent step, or may be subjected to full-body cutting and processing related to the manufacture, such as film formation processing.

With this configuration, as in the above-mentioned case, it is possible to eliminate waste to be generated from the fact that the support glass to be disposed of is thicker than the glass film, and to achieve light-weighting of the glass film laminate and higher handling efficiency of the glass film laminate. Further, in this case, the above-mentioned effects on the packaging and transportation are effectively exerted when the step of manufacturing the glass film laminate is carried out in a factory or the like that is different from that for the step of performing the processing related to the manufacture, such as the scribe line formation.

### Advantageous Effects of Invention

As described above, according to the present invention, the glass film having a thickness of 200 μm or less appropriately adheres to the support glass, and hence, when the glass film is subjected to the laser heating followed by the subsequent cooling, a sufficient thermal stress is generated in the thickness direction of the laminate that may be assumed as a unit of the glass film and the support glass. As a result, the appropriate scribe line can be formed in the glass film.

### BRIEF DESCRIPTION OF DRAWINGS

FIG. 1a A schematic perspective view illustrating a practical situation of a laminate manufacturing step of a glass film cutting method according to an embodiment of the present invention.

FIG. 1b A schematic perspective view illustrating a glass film laminate obtained in the laminate manufacturing step of the glass film cutting method according to the embodiment of the present invention.

FIG. 2 A schematic perspective view illustrating another glass film laminate obtained in the laminate manufacturing step of the glass film cutting method according to the embodiment of the present invention.

FIG. 3 A schematic perspective view illustrating a practical situation of a laser scribing step of the glass film cutting method according to the embodiment of the present invention.

FIG. 4a A schematic plan view illustrating the practical situation of the laser scribing step of the glass film cutting method according to the embodiment of the present invention.

FIG. 4b A sectional view taken along the line C-C (and a sectional view taken along the line D-D) of FIG. 4a.

FIG. 5 A schematic plan view illustrating the practical situation of the laser scribing step of the glass film cutting method according to the embodiment of the present invention.

FIG. 6 A schematic perspective view illustrating a glass film laminate obtained in the laser scribing step of the glass film cutting method according to the embodiment of the present invention.

FIG. 7 A schematic perspective view illustrating a practical situation of a separation step of the glass film cutting method according to the embodiment of the present invention.

FIG. 8 A schematic perspective view illustrating a practical situation of a snapping step of the glass film cutting method according to the embodiment of the present invention.

FIG. 9 A schematic perspective view illustrating another glass film laminate obtained in a laminate manufacturing step of a glass film cutting method according to another embodiment of the present invention.

FIG. 10 A schematic side view illustrating a practical situation of a bending test according to examples of the present invention.

FIG. 11 A schematic perspective view illustrating a problem inherent in a conventional technology.

FIG. 12 A schematic perspective view illustrating a practical situation of a laser scribing step of a general glass sheet cutting method according to the conventional technology.

FIG. 13a An enlarged vertical sectional side view illustrating the practical situation of the laser scribing step of the general glass sheet cutting method according to the conventional technology.

FIG. 13b An enlarged vertical sectional side view of a glass film, for illustrating a problem inherent in the conventional technology.

### DESCRIPTION OF EMBODIMENTS

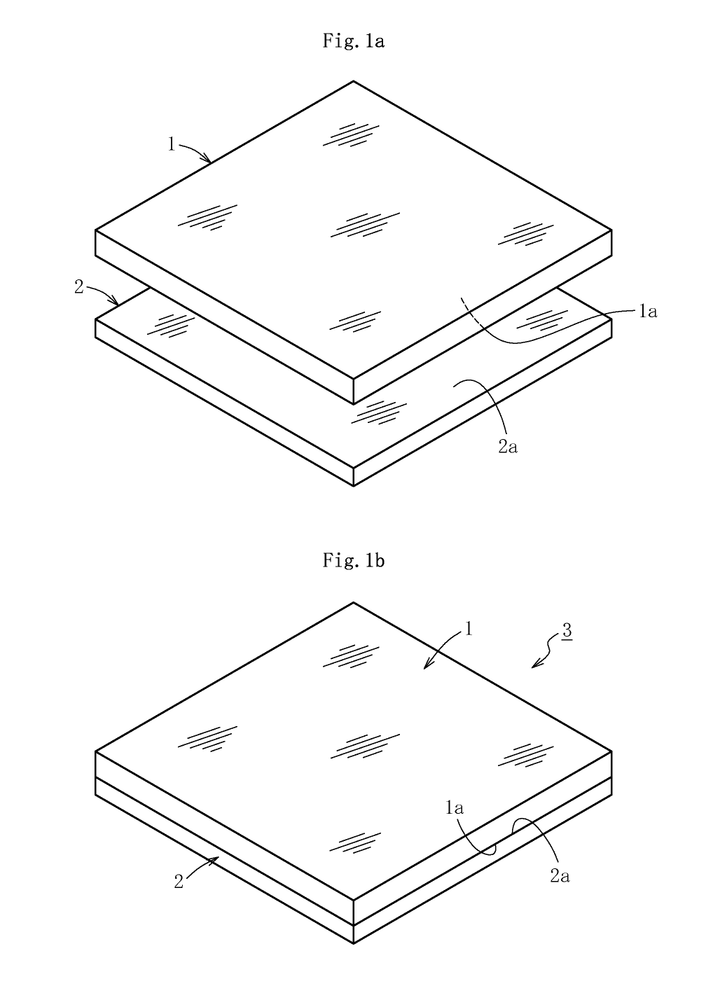

In the following, a glass film cutting method and a glass film laminate according to embodiments of the present invention are described with reference to the accompanying drawings. Note that, FIGS. 1 to 9 are perspective view etc illustrating a practical situation of the glass film cutting method (hereinafter referred to simply as “cutting method”) according to the embodiments of the present invention.

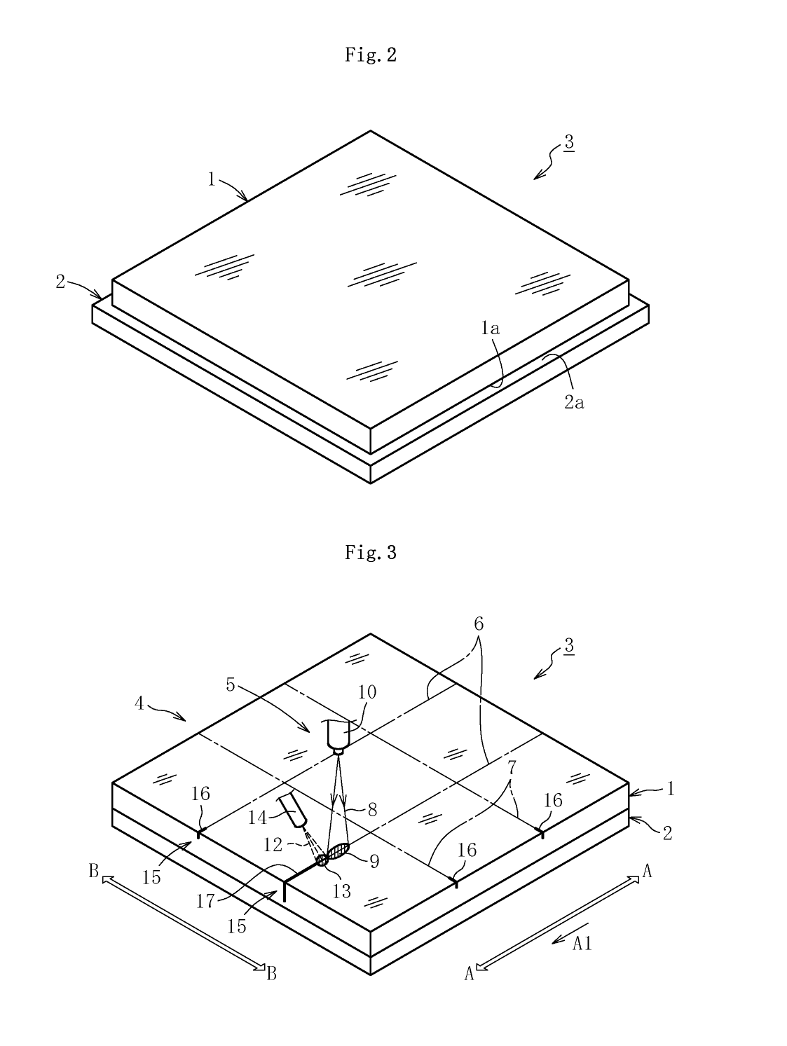

FIG. 1 illustrate an example of a practical situation of a laminate manufacturing step of the cutting method according to an embodiment of the present invention. In this laminate manufacturing step, a glass film laminate 3 (hereinafter referred to simply as “laminate 3”) illustrated in FIG. 1b is obtained only by bringing, as illustrated in FIG. 1a, a substantially rectangular glass film 1 having a thickness of 200 μm or less into surface contact with a film-like support glass 2 having the same area and shape as the glass film 1 but a smaller thickness than the glass film 1. In this case, a side of each of the glass film 1 and the support glass 2 has a length of 100 mm to 1,000 mm. Further, a contact surface 1a of the glass film 1 has a surface roughness Ra of 2.0 nm or less, and a contact surface 2a of the support glass 2 also has a surface roughness Ra of 2.0 nm or less. Further, it is preferred that the thickness of the laminate 3 be 250 μm or more, and the thickness of the support glass 2 be 50 μm or more. Note that, as illustrated in FIG. 2, the laminate 3 may be formed so that the area of the glass film 1 is set smaller than the area of the support glass 2 and all peripheral edges (alternatively, one or two peripheral edges) of the support glass 2 project from the glass film 1. In this case, the glass film 1 and the support glass 2 may be made of the same kind of material or different kinds of material.

Now, description is given of an adhesion force to be generated through the surface contact between the glass film 1 and the support glass 2 described above. The adhesion force may be generated due to the following phenomenon. That is, when the contact surface 1a of the glass film 1 is brought into surface contact with the contact surface 2a of the support glass 2, under a condition that the surface roughnesses Ra of both the contact surfaces 1a and 2a are set to 2.0 nm or less, one of the contact surfaces is slightly charged at a positive polarity, and the other of the contact surfaces is slightly charged at a negative polarity. As a result, there arises such a phenomenon that the contact surfaces 1a and 2a attract each other (so-called hydrogen bond). In this case, when the temperatures of both the contact surfaces 1a and 2a become higher than about 250° C., a covalent bond occurs between the contact surfaces 1a and 2a, and hence the glass film 1 and the support glass 2 cannot be separated from each other. When the hydrogen bond occurs as described above, however, the glass film 1 and the support glass 2 can be separated from each other.

FIG. 3 illustrates an example of a practical situation of a laser scribing step of the cutting method according to the embodiment of the present invention. As illustrated in FIG. 3, a scribe line forming apparatus 4 to be used in the laser scribing step comprises a support base (not shown) for supporting the laminate 3 in a horizontal posture and moving the laminate 3 in a first direction (direction A-A) and in a second direction (direction B-B) orthogonal to the first direction, and scribing means 5 for performing laser scribing on the glass film 1 of the laminate 3 that is placed on the support base. In this case, the glass film 1 of the laminate 3 has a plurality of (in the example of FIG. 3, two) first preset cleaving lines 6 extending along the first direction, and a plurality of (in the example of FIG. 3, two) second preset cleaving lines 7 extending along the second direction. Further, the scribing means 5 comprises a laser irradiation device 10 for irradiating one of the first preset cleaving lines 6 (or the second preset cleaving lines 7) of the glass film 1 with a laser beam 8 to form a heated region 9 in the process of moving the laminate 3 in the first direction (or the second direction), and a fluid supplying device 14 for supplying a cooling fluid 12 subsequently to the heating of the laser beam 8 to form a cooled region 13.

According to the above-mentioned configuration of the scribe line forming apparatus 4, through the movement of the laminate 3 in the arrow A1 direction of FIG. 3, the heated region 9 formed using the laser beam 8 and the subsequent cooled region 13 formed using the cooling fluid 12 are shifted from a leading end side along the first preset cleaving line 6 of the glass film 1. At the time of shifting, an initial crack 16 formed at a leading end position 15 of the first preset cleaving line 6 is propagated by a thermal stress generated due to a temperature difference between the regions 9 and 13, and accordingly a scribe line 17 is formed on the first preset cleaving line 6 of the glass film 1. This operation is carried out while appropriately moving the support base and appropriately changing the orientations of the laser irradiation device 10 and the fluid supplying device 14, with the result that the scribe lines 17 are formed on all the first preset cleaving lines 6 and the second preset cleaving lines 7. During this operation, due to the adhesion force generated through the surface contact between the glass film 1 and the support glass 2, the glass film 1 and the support glass 2 are not separated from each other or move relative to each other in a direction along the surfaces thereof.

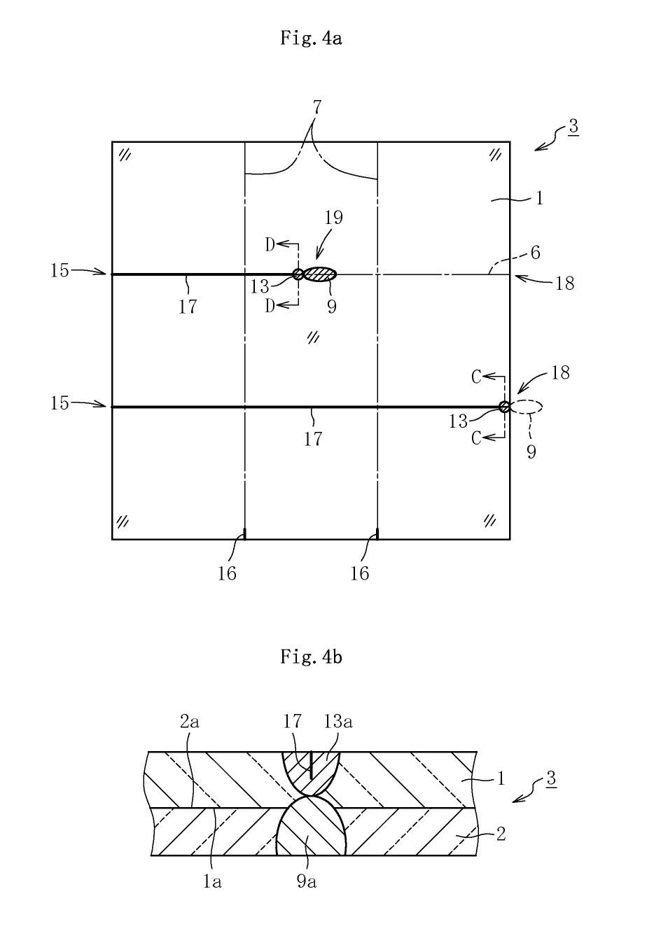

In this case, as illustrated in FIG. 4a, a temperature distribution in a thickness direction at a middle position 19 between the leading end position 15 and a terminal end position 18 of the first preset cleaving line 6 of the glass film 1 (the same applies to the case of the second preset cleaving line 7) is slightly different from a temperature distribution in the thickness direction at the terminal end position 18 of the first preset cleaving line 6, but at any positions, a cooled region 13a and a heated region 9a are formed in a range from the glass film 1 to the support glass 2 as illustrated in FIG. 4b. This phenomenon occurs because the glass film 1 and the support glass 2 adhere to each other through the surface contact therebetween and may be assumed as a unit. In particular, as illustrated in FIG. 4a, at the terminal end position 18 of the first preset cleaving line 6 of the glass film 1, in the direction along the surface thereof, the cooled region 13 remains but the heated region 9 disappears. At this time, the heated region 9a, which is formed in the thickness direction of the laminate 3 by the time when the heated region 9 disappears, remains in the thickness direction of the laminate 3 even at the above-mentioned terminal end position 18 of the glass film 1, and hence, as illustrated in FIG. 4b, the cooled region 13a and the heated region 9a are formed in the entire range in the thickness direction of the laminate 3. Thus, a desired thermal stress (tensile stress) is generated at any position on both the first preset cleaving lines 6 and the second preset cleaving lines 7, with the result that the appropriate scribe lines 17 are formed over the entire length of the surface of the glass film 1 in the first direction (the same applies to the case of the second direction). In this embodiment, the thickness of the support glass 2 is smaller than the thickness of the glass film 1, and hence the thermal stress to be generated is suppressed at an appropriate level. This configuration is advantageous in that the operation involves only the formation of the scribe lines 17 without full-body cutting of the glass film 1.

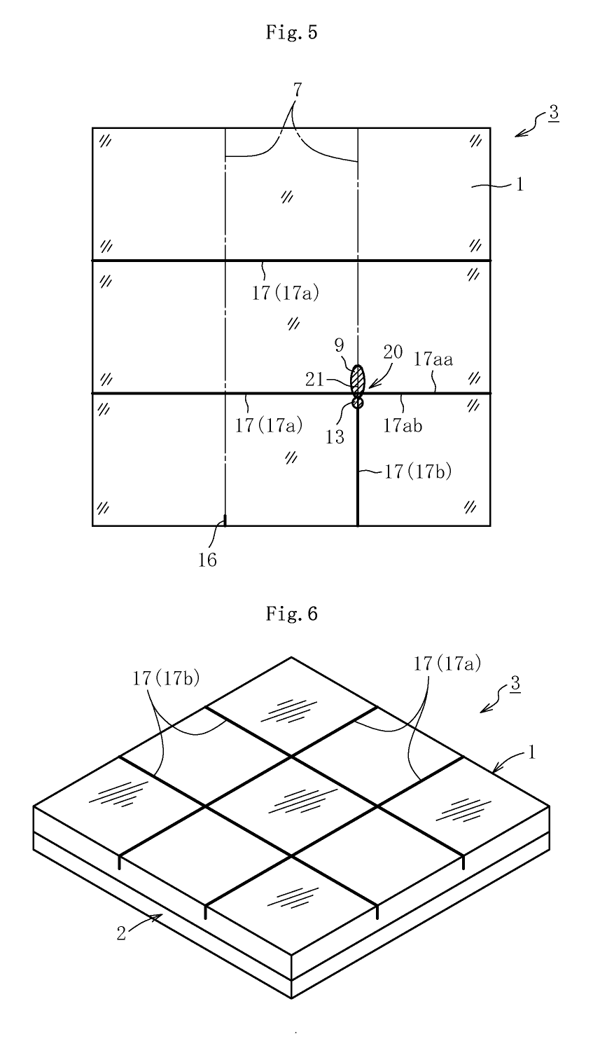

Further, as illustrated in FIG. 5, in the process of forming the scribe lines 17 along the second preset cleaving lines (in this paragraph, referred to as “second scribe lines 17b”) after forming the scribe lines 17 along the first preset cleaving lines 6 (in this paragraph, referred to as “first scribe lines 17a”), when the second scribe line 17b passes across the first scribe line 17a, the second scribe line 17b is formed continuously without being interrupted at a passing point 20 therebetween. This is because, under a state in which the first scribe line 17a is formed, opposing cleaved surfaces 17aa and 17ab defining the first scribe line 17a may be assumed to be substantially in contact with each other though the cleaved surfaces 17aa and 17ab are separated from each other in terms of molecules thereof. Therefore, there is no need to form an initial crack at a leading end portion 21 at which the second scribe line 17b passes across the first scribe line 17a, with the result that the work of forming initial cracks is facilitated. When the operation described above is completed, the laminate 3 having all the scribe lines 17 (17a and 17b) formed therein is obtained as illustrated in FIG. 6.

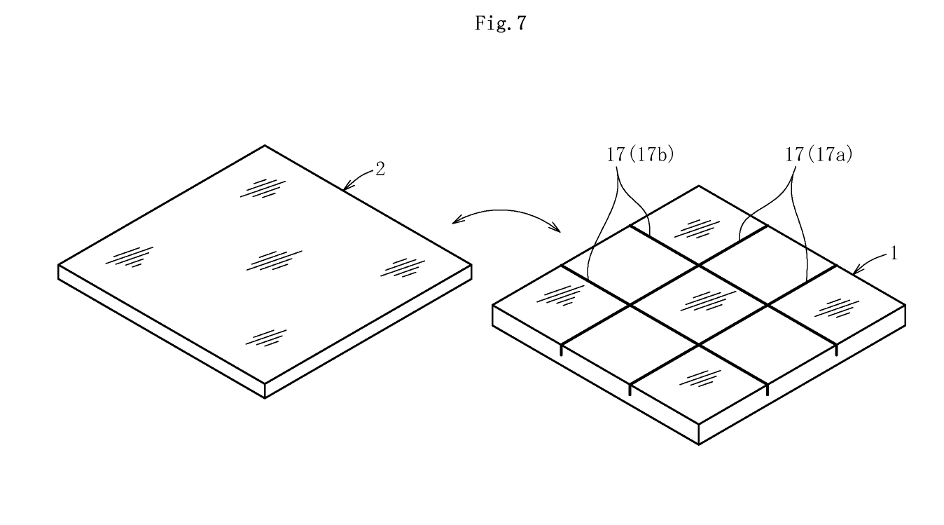

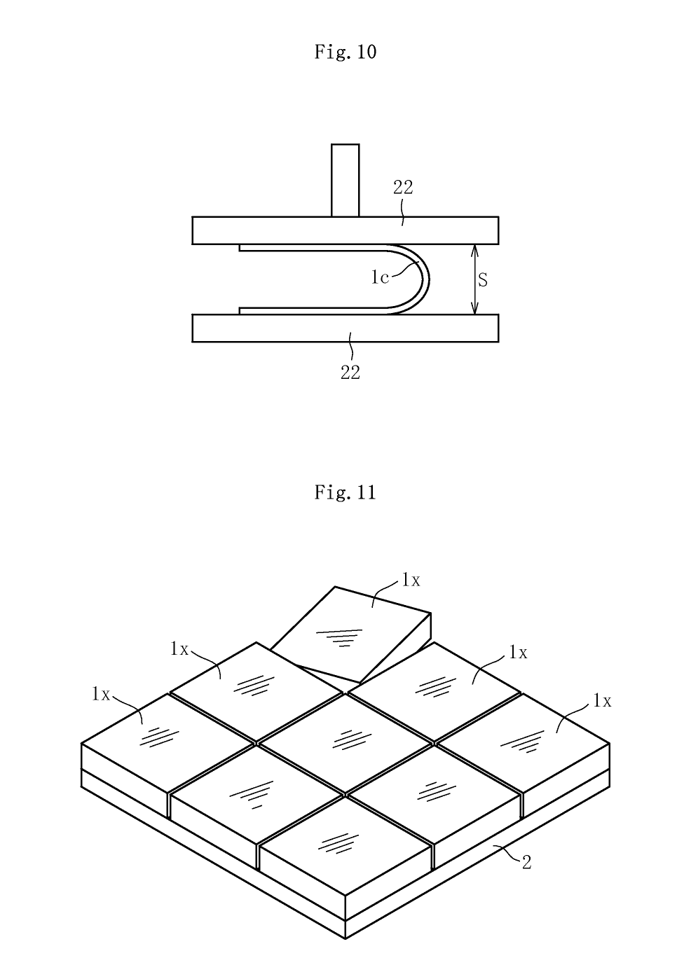

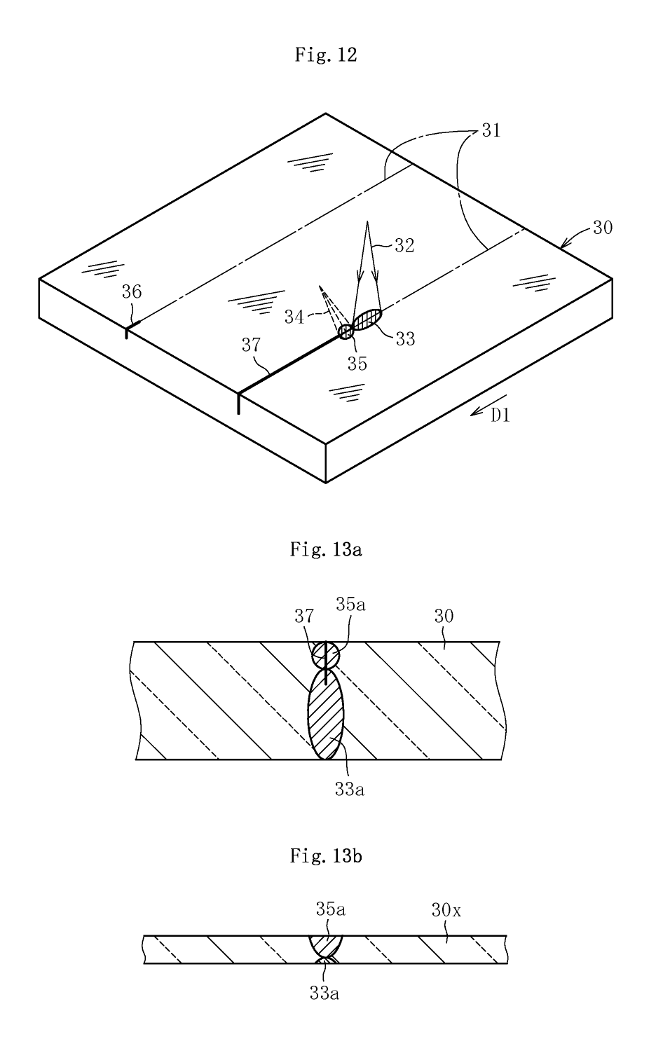

FIG. 7 illustrates an example of a practical situation of a separation step of the cutting method according to the embodiment of the present invention. As illustrated in FIG. 7, in this separation step, the glass film 1 having all the scribe lines 17 (17a and 17b) formed therein is separated as it is from the support glass 2 by releasing the adhesion force generated through the surface contact therebetween. The adhesion force generated through the surface contact between the glass film 1 and the support glass 2 is released in the following manner. That is, the surface contact state is terminated by, for example, applying an external force so as to introduce air into the surface contact portion between the glass film 1 and the support glass 2. In this manner, the glass film 1 and the support glass 2 can easily be separated from each other. It is considered that the glass film 1 and the support glass 2 can easily be separated from each other as described above because the temperature in the laser scribing step does not rise to such a degree that a covalent bond occurs between the glass film 1 and the support glass 2, but is maintained in a state in which a hydrogen bond occurs therebetween. Further, the glass film 1 subjected only to the formation of the scribe lines 17 (17a and 17b) as described above is separated as it is from the support glass 2, and thus the following advantage can be obtained. That is, in a case where the glass film 1 is subjected to full-body cutting along the first preset cleaving lines and the second preset cleaving lines as illustrated in, for example, FIG. 11, there may occur such a situation that, when glass film pieces 1x after the cutting are individually separated from the support glass 2, edges of the adjacent glass film pieces 1x are brought into locally close contact with each other to cause damage and the like, resulting in generation of a defective product. However, such a trouble does not occur in the case where the glass film 1 subjected only to the formation of the scribe lines 17 (17a and 17b) is separated from the support glass 2.

FIG. 8 illustrates an example of a practical situation of a snapping step of the cutting method according to the embodiment of the present invention. As illustrated in FIG. 8, in this snapping step, the glass film 1 separated from the support glass 2 is snapped along the scribe lines 17 (17a and 17b), and thus the glass film 1 is separated into a plurality of (in the example of FIG. 8, nine) glass film pieces 1c. As a technique of snapping the glass film 1, a known automatic snapping device may be used, or the glass film 1 may manually be snapped instead. Also at the time of snapping the glass film 1, edges of the adjacent glass film pieces 1c are not brought into locally close contact with each other, and hence the damage to the glass film pieces 1c and the generation of a defective product can be prevented reliably.

As described above, in the process of forming the laminate 3 through the surface contact between the glass film 1 and the support glass 2, forming the scribe lines 17 (17a and 17b) in the glass film 1 of the laminate 3, then separating the glass film 1 from the support glass 2, and separating the glass film 1 into the plurality of glass film pieces 1c, the laminate 3 is packaged and transported in the following two forms. That is, the laminate 3 is packaged and transported in the first form in a case where the laminate manufacturing step is carried out in a factory or the like that is different from that for the subsequent steps (laser scribing step, separation step, and snapping step). In this case, as illustrated in FIGS. 1b and 2, there are manufactured a plurality of laminates 3 each obtained by adhering the glass film 1 and the support glass 2 to each other through the surface contact therebetween, that is, a plurality of laminates 3 each comprising the glass film 1 with no scribe lines yet formed therein and the support glass 2. The plurality of laminates 3 are transported to a different factory or the like in a state of being packaged into one bundle through use of a packaging material or the like. At the time of the transportation in this case, the glass film 1 and the support glass 2 of each laminate 3 are not separated from each other. After the transportation, the above-mentioned laser scribing step, separation step, and snapping step are carried out at the different factory or the like. On the other hand, the laminate 3 is packaged and transported in the second form in a case where the laminate manufacturing step and the laser scribing step are carried out in a factory or the like that is different from that for the separation step and the snapping step. In this case, as illustrated in FIG. 6, there are manufactured a plurality of laminates 3 each comprising the glass film 1 having the scribe lines 17 (17a and 17b) formed therein. The plurality of laminates 3 are transported to a different factory or the like in a state of being packaged into one bundle through use of a packaging material or the like. Also at the time of the transportation in this case, the glass film 1 and the support glass 2 of each laminate 3 are not separated from each other. After the transportation, the above-mentioned separation step and snapping step are carried out at the different factory or the like.

Through the operation described above, in the laminate manufacturing step, the glass film 1 having the contact surface 1a with the surface roughness Ra of 2.0 nm or less and the support glass 2 having the contact surface 2a with the surface roughness Ra of 2.0 nm or less are laminated in surface contact (specifically, direct surface contact) with each other, and hence the glass film 1 and the support glass 2 are maintained in a state of appropriately adhering to each other even without using an adhesive or a pressure-sensitive adhesive. Therefore, when the glass film 1 is subjected to the heating of the laser beam 8 followed by the subsequent cooling of the cooling fluid 12, the cooled region 13a and the heated region 9a are formed in the thickness direction of the laminate 3 that may be assumed as a unit of the glass film 1 and the support glass 2. In other words, the cooled region 13a and the heated region 9a are formed in the thickness direction under a state in which the shortage of the thickness of the glass film 1 is compensated with the thickness of the support glass 2. Therefore, even in the case of the glass film 1 having a thickness of 200 μm or less, a desired thermal stress (tensile stress) is generated in the thickness direction of the laminate 3 comprising the glass film 1, and hence the appropriate scribe lines 17 (17a and 17b) are formed in the glass film 1 due to the thermal stress.

Moreover, in the separation step following the laminate manufacturing step and the laser scribing step, the glass film 1 having the scribe lines 17 (17a and 17b) formed therein, that is, the glass film 1 that is not yet separated into a plurality of pieces, is separated from the support glass 2, and hence there is no factor in the damage such as a flaw in the glass film 1 at the time of separation, with the result that the generation of a defective product can be avoided effectively. Further, no adhesive or pressure-sensitive adhesive is interposed as a layer between the glass film 1 and the support glass 2, and hence there is even no such situation that the glass film 1 is contaminated after the separation. As a result, the plurality of separated glass film pieces 1c can be obtained in a clean state with high quality.

In addition, in the laminate 3 illustrated in FIGS. 1b and 2, the thickness of the support glass 2 is smaller than the thickness of the glass film 1, and hence the thermal stress to be generated in the glass film 1 is suppressed at an appropriate level. This configuration is advantageous in that the operation involves only the formation of the scribe lines 17 (17a and 17b). In addition, it is possible to eliminate waste to be generated from the fact that the support glass 2 to be disposed of is thicker, and to contribute to light-weighting, thinning, and higher handling efficiency of the laminate 3. Further, due to the higher handling efficiency of the laminate 3 and the like, the packaging work at the time of transportation is facilitated, and due to the light-weighting and the thinning, the stacking efficiency and the transportation efficiency are enhanced as well.

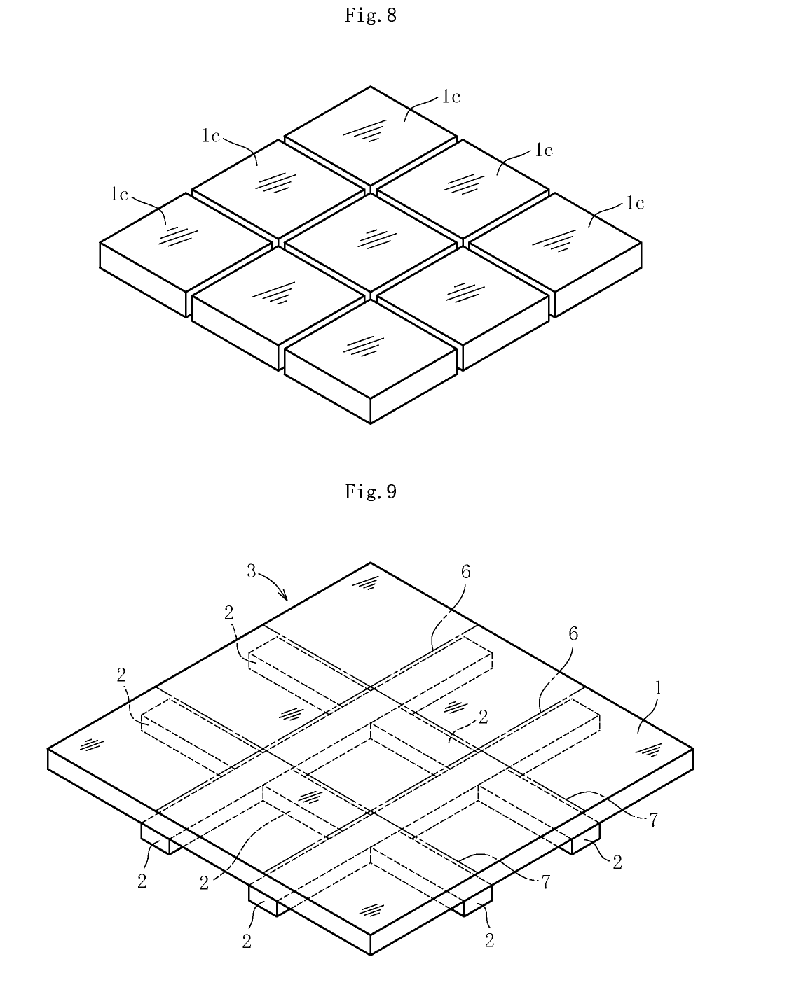

FIG. 9 is a perspective view illustrating a practical situation of a laminate manufacturing step of a glass film cutting method according to another embodiment of the present invention. The laminate manufacturing step according to the another embodiment is different from the laminate manufacturing step according to the above-mentioned embodiment in that the support glass 2 of the laminate 3 comprises support glasses arranged so as to extend along the first preset cleaving lines 6 and the second preset cleaving lines 7.

Specifically, the support glass 2 comprises two longer support glasses 2 extending in a direction along the first preset cleaving lines 6, and six shorter support glasses 2 extending in a direction along the second preset cleaving lines 7. Further, the shorter support glasses 2 abut against the longer support glasses 2 at one or both end portions of the shorter support glasses 2, and are arranged in a direction orthogonal to the longer support glasses 2 under a state in which the longer support glasses 2 are each interposed between the shorter support glasses 2.

Also in the case where the glass film 1 and the support glasses 2 are laminated as in this embodiment, similarly to the above-mentioned embodiment, the scribe lines 17 are smoothly formed in the glass film 1. Further, with this configuration, the area of the contact surfaces of the glass film 1 and the support glasses 2 is reduced, and hence, as compared to the case where the glass film 1 and the support glass 2 are laminated in surface contact with each other over the entire surfaces thereof, it is possible to avoid such a situation that creases are generated due to local separation of the glass film 1 from the support glass 2 at the time of carrying out the laminate manufacturing step. Thus, it is possible to reduce a probability of distortion that may occur in the glass film 1 due to the separation of the glass film 1.

Further, when the glass film 1 is separated from the support glass 2 after the laser scribing step is finished, the separation of the glass film 1 is facilitated. Moreover, when the support glass 2 is washed and dried or inspection is carried out for the presence and absence of remaining foreign matter after the glass film 1 is separated from the support glass 2, it is possible to reduce the time and effort to be required for those kinds of work.

Note that, in the embodiments described above, the thickness of the support glass 2 is set smaller than the thickness of the glass film 1 in which the scribe lines 17 (17a and 17b) are to be formed. Alternatively, the thickness of the support glass 2 may be set larger than the thickness of the glass film 1 as long as the temperature distributions of the heating and cooling are set appropriately. Further, in the embodiments described above, the scribe lines 17 (17a and 17b) are formed under the condition that the laminate 3 is moved and the laser irradiation device 10 and the fluid supplying device 14 are installed stationarily. Alternatively, the laminate 3 may be installed stationarily and the laser irradiation device 10 and the fluid supplying device 14 may be moved. As described above, the laminate 3 illustrated in FIGS. 1b, 2, and 9 is not limited to the laminate 3 comprising the glass film 1 in which the scribe lines 17 are to be formed, but the laminate 3 may comprise the glass film 1 to be subjected to full-body cutting. Alternatively, the laminate 3 may comprise the glass film 1 to be subjected to processing related to the manufacture, such as film formation processing.

### EXAMPLES

As shown in Table 1 below, Examples 1 to 5 of the present invention are each directed to a case where the laminate is manufactured by adhering the glass film, in which the scribe lines are to be formed, and the support glass to each other through the surface contact therebetween, and the surface roughnesses Ra of the contact surfaces of the glass film and the support glass are set to 2.0 nm or less. On the other hand, Comparative Examples 1 and 2 are each directed to a case where the laminate is manufactured from the glass film and the support glass in a manner similar to the above, but one of the surface roughnesses Ra of the contact surfaces of the glass film and the support glass is more than 2.0 nm. Further, Comparative Examples 3 and 4 are each directed to a case where the support glass is not provided.

In each of Examples 1 to 5 and Comparative Examples 1 to 4, through use of alkali-free glass (OA-10G) manufactured by Nippon Electric Glass Co., Ltd., the sizes of the glass film and the support glass were set to 300 mm×300 mm, and the thicknesses of the glass film and the support glass were set as shown in Table 1 below. Further, for the contact surfaces of the glass film and the support glass, glass formed by an overflow downdraw method was used under an unpolished state, or the degrees of polishing and chemical etching were adjusted in terms of concentration, liquid temperature, and processing time.

The surface roughnesses Ra of the contact surfaces of the glass film and the support glass were measured through use of a scanning prove microscope (NanoNabi II/S-image) manufactured by SII at a scanning area of 2,000 nm, a scanning frequency of 0.95 Hz, and a scanning data count of X: 256 and Y: 256. The surface roughness Ra of each of the above-mentioned glass film and support glass was represented by an average value of surface roughnesses Ra at two points in total, that is, one point at a center portion and one point at a corner portion of each of the glass film and the support glass.

At a leading end position on a preset cleaving line of the glass film, an initial crack was formed due to a pressing force of 0.05 MPa through use of a sintered-diamond scribing wheel (manufactured by Mitsuboshi Diamond Industrial Co., LTD.) having a diameter of 2.5 mm, a blade thickness of 0.65 mm, and a wedge angle of 100°. A laser beam used for forming a scribe line was generated through use of a carbon dioxide laser manufactured by Coherent, Inc. as an elliptical beam that was long in a direction along the preset cleaving line through an optical lens system. Further, the scribe line was formed by propagating the initial crack due to a thermal stress generated by heating the glass film through laser irradiation and cooling the glass film through spraying of water at a rate of 4 cc/minute with a pressure of 0.4 MPa. The laser output in this case was 160 w, and the rate of the scribe line formation was 500 mm/second.

In each of the glass films of Examples 1 to 5 and Comparative Examples 1 to 4, three scribe lines were formed at regular intervals in a first direction along one side of the glass film, and three scribe lines were formed at regular intervals also in a second direction orthogonal to the first direction. Further, Table 1 below shows “success and failure of the laser scribing cross cut” in this case, that is, evaluation of results of forming the above-mentioned three scribe lines along the first direction and the above-mentioned three scribe lines along the second direction while crossing each other. In Table 1 below, the symbol “⊚” represents that the scribe lines were formed in an excellent condition, the symbol “∘” represents that the scribe lines were formed in a good condition, which was however slightly inferior to the case of the symbol “⊚”, and the symbol “x” represents that the scribe lines were not formed.

After the above-mentioned scribe lines were formed, a pressure-sensitive adhesive tape was adhered to the corner portion of the glass film to peel the glass film off the support glass. In this manner, the glass film was separated from the support glass. After that, the glass film was snapped along the scribe lines to obtain sixteen glass film pieces. Then, the strengths of those glass film pieces 1c were evaluated by so-called two-point bending, in which the glass film pieces 1c were sequentially sandwiched between two plate-like members 22 and were pressed and bent as illustrated in FIG. 10 so as to form a U-shaped bend. This evaluation was conducted by calculating a bending fracture strength based on a distance S between the two plate-like members 22 at the time when each of the glass film pieces 1c was damaged due to the bending by pressing. Table 1 below shows results thereof.

TABLE 1

| | Example | Example | Example | Example | Example | Comparative | Comparative | Comparative | Comparative |
|---|---|---|---|---|---|---|---|---|---|
| | 1 | 2 | 3 | 4 | 5 | Example 1 | Example 2 | Example 3 | Example 4 |
| Thickness of | 100 | 100 | 200 | 100 | 100 | 100 | 100 | 100 | 100 |
| glass film (μm) | | | | | | | | | |
| Thickness of | 500 | 150 | 50 | 150 | 130 | 150 | 150 | — | — |
| support glass | | | | | | | | | |
| (μm) | | | | | | | | | |
| Thickness of | 600 | 250 | 250 | 250 | 230 | 250 | 250 | — | — |
| laminate (μm) | | | | | | | | | |
| Surface | 0.2 | 0.2 | 0.2 | 2.0 | 0.2 | 2.5 | 0.2 | 0.2 | 0.2 |
| roughness of | | | | | | | | | |
| glass film (nm) | | | | | | | | | |
| Surface | 0.2 | 0.2 | 0.2 | 2.0 | 0.2 | 0.2 | 2.5 | — | — |
| roughness of | | | | | | | | | |
| support glass | | | | | | | | | |
| (nm) | | | | | | | | | |
| Success and | ⊚ | ⊚ | ⊚ | ⊚ | ◯ | X | X | X | Chip |
| failure of laser | | | | | | | | | scribing |
| scribing cross | | | | | | | | | |
| cut | | | | | | | | | |
| Bending fracture | 450 | 450 | 480 | 470 | 430 | — | — | — | 120 |
| stress (MPa) | | | | | | | | | |

Referring to Table 1 above, in each of Examples 1 to 4, the surface roughnesses Ra of both the contact surfaces of the glass film and the support glass were 2.0 nm or less, and the thickness of the laminate was 250 μm or more. Thus, it was confirmed that, even when the thickness of the glass film was 200 μm or less, the scribe lines were formed in the glass film in an excellent condition and the bending fracture stress of each of the glass film pieces after snapping the glass film was sufficiently high as well. Of those examples, Example 3 shows that the thickness of the support glass was smaller than the thickness of the glass film, and hence it was grasped that the scribe lines were formed in a particularly excellent condition and the bending fracture stress of each of the glass film pieces after snapping the glass film was particularly high as well. Further, in Example 5, the surface roughnesses Ra of both the contact surfaces of the glass film and the support glass were 2.0 nm or less and the thickness of the glass film was 200 μm or less, but the thickness of the laminate was 230 μm. Therefore, the scribe lines were formed in the glass film in a slightly inferior condition, and the bending fracture stress of each of the glass film pieces after snapping the glass film was slightly lower as well. It was however confirmed that no problem arose in Example 5, eventually.

In contrast, in Comparative Examples 1 and 2, one of the surface roughness Ra of the contact surface of the glass film and the surface roughness Ra of the contact surface of the support glass was more than 2.0 nm. Thus, the adhesiveness of the contact surfaces of both the glass film and the support glass was not appropriate, and due to the inappropriate adhesiveness, a desired thermal stress was not generated, with the result that the scribe lines were not formed in the glass film. Further, in Comparative Example 3, only the glass film having a thickness of 200 μm was provided, and the support glass was not provided. Therefore, the laser output was adjusted within a range of 50 to 200 w, and the rate of the scribe line formation was adjusted within a range of 50 to 600 mm. However, there was no condition appropriate to form the scribe lines. Moreover, in Comparative Example 4, the scribe lines were formed only in a glass film having a thickness of 100 μm through use of the scribing wheel, and then glass film pieces were obtained through snapping. However, the bending fracture stress of each of those glass film pieces was considerably lower as compared to the glass film pieces according to Examples 1 to 5, thus leading to the conclusion that the glass film pieces had a risk of susceptibility to damage.

From the results described above, it was confirmed that, in Examples 1 to 5 of the present invention, a plurality of scribe lines were formed while crossing each other in a better condition and obtained cleaved end surfaces had a sufficiently high strength to lower the susceptibility to damage as compared to Comparative Examples 1 to 4.

### REFERENCE SIGNS LIST

1 glass film
1a contact surface of glass film (contact-side surface)
2 support glass
2a contact surface of support glass (contact-side surface)
3 laminate
8 laser beam
12 cooling fluid
16 initial crack
17 scribe line
17a first scribe line
17b second scribe line

1. A glass film cutting method, comprising:
a laser scribing step of forming a scribe line in a glass film having a thickness of 200 μm or less by propagating an initial crack through laser heating of the glass film followed by subsequent cooling of the glass film; and
a laminate manufacturing step of manufacturing a glass film laminate by setting a surface roughness Ra of each of a surface of the glass film to be brought into contact with a support glass, which is configured to support the glass film, and a surface of the support glass to be brought into contact with the glass film to 2.0 nm or less, and by bringing the surface of the glass film and the surface of the support glass into surface contact with each other, followed by the laser scribing step.

2. The glass film cutting method according to claim 1, further comprising:
a separation step of separating, from the support glass, the glass film having the scribe line formed therein; and
a snapping step of snapping the separated glass film along the scribe line,
the separation step and the snapping step following the laser scribing step.

3. The glass film cutting method according to claim 1, wherein the laser scribing step comprises forming a plurality of scribe lines crossing each other.

4. The glass film cutting method according to claim 1, wherein the support glass of the glass film laminate comprises support glasses arranged so as to extend along preset cleaving lines, along which the scribe lines are to be formed in the glass film.

5. The glass film cutting method according to claim 1, wherein the support glass of the glass film laminate is thinner than the glass film.

6. A glass film laminate, comprising:
a glass film having a thickness of 200 μm or less; and
a support glass, which is configured to support the glass film,
wherein a surface of the glass film to be brought into contact with the support glass has a surface roughness Ra of 2.0 nm or less, and a surface of the support glass to be brought into contact with the glass film has a surface roughness Ra of 2.0 nm or less,
wherein the surface of the glass film and the surface of the support glass are brought into surface contact with each other to laminate the glass film and the support glass,
wherein the glass film comprises a scribe line formed therein by propagating an initial crack through laser heating of the glass film followed by subsequent cooling of the glass film, and
wherein the support glass is thinner than the glass film.

7. A glass film laminate, comprising:
a glass film having a thickness of 200 μm or less; and
a support glass, which is configured to support the glass film,
wherein a surface of the glass film to be brought into contact with the support glass has a surface roughness Ra of 2.0 nm or less, and a surface of the support glass to be brought into contact with the glass film has a surface roughness Ra of 2.0 nm or less,
wherein the surface of the glass film and the surface of the support glass are brought into surface contact with each other to laminate the glass film and the support glass, and
wherein the support glass is thinner than the glass film.

8. The glass film cutting method according to claim 2, wherein the laser scribing step comprises forming a plurality of scribe lines crossing each other.

9. The glass film cutting method according to claim 2, wherein the support glass of the glass film laminate comprises support glasses arranged so as to extend along preset cleaving lines, along which the scribe lines are to be formed in the glass film.

10. The glass film cutting method according to claim 3, wherein the support glass of the glass film laminate comprises support glasses arranged so as to extend along preset cleaving lines, along which the scribe lines are to be formed in the glass film.

11. The glass film cutting method according to claim 8, wherein the support glass of the glass film laminate comprises support glasses arranged so as to extend along preset cleaving lines, along which the scribe lines are to be formed in the glass film.

12. The glass film cutting method according to claim 2, wherein the support glass of the glass film laminate is thinner than the glass film.

13. The glass film cutting method according to claim 3, wherein the support glass of the glass film laminate is thinner than the glass film.

14. The glass film cutting method according to claim 4, wherein the support glass of the glass film laminate is thinner than the glass film.

15. The glass film cutting method according to claim 8, wherein the support glass of the glass film laminate is thinner than the glass film.

16. The glass film cutting method according to claim 9, wherein the support glass of the glass film laminate is thinner than the glass film.

17. The glass film cutting method according to claim 10, wherein the support glass of the glass film laminate is thinner than the glass film.

18. The glass film cutting method according to claim 11, wherein the support glass of the glass film laminate is thinner than the glass film.
